(19) United States
(12) Patent Application Publication
(10) Pub. No.: US 2010/0332959 A1
(43) Pub. Date: Dec. 30, 2010

(54) System and Method of Capturing a Multi-Media Presentation for Delivery Over a Computer Network

(75) Inventors: Scott L. Mitchell, Phoenix, AZ (US); Stephane G. Legay, Phoenix, AZ (US)

Correspondence Address: Robert D. Atkins, 605 W. Knox Road, Suite 104, Tempe, AZ, 85284, US

(73) Assignee: NEXTSLIDE, LLC, Phoenix, AZ (US)

(21) Appl. No.: 12/491,142

(22) Filed: Jun. 24, 2009

(51) Int. Cl. G06F 17/00; G06F 3/14

(52) U.S. Cl. 715/202; 715/730; 715/203

(57) ABSTRACT

A multi-media presentation system converts frame-based content from the presentation into a collection of slide assets of a multi-media file type. A time-based content recorded during the presentation is converted into a collection of audio/video assets of the multi-media file type. The time-based content includes one or more of audio and video recorded during the presentation. A presentation control file is generated having a sequence of control segments. Each control segment specifies playback duration for one of the slide and audio/video assets, and placement information indicating control segment placement within the sequence. The slide assets, the audio/video assets, and the presentation control file are packaged as a collection of files readable by a player that, responsive to reading the presentation control file, plays the presentation as a series of assets synchronized according to the playback durations and placement information specified by the control segments.

### FIELD OF THE INVENTION

The present invention relates generally to capture and delivery of multi-media presentations, and more specifically to a system and method of converting different presentation media to a common type to facilitate synchronization, packaging, and delivery over computer networks.

### BACKGROUND OF THE INVENTION

It is now common practice in business and educational forums for oral presenters to utilize software tools when creating and delivering oral presentations. Software tools such as Microsoft Power Point, Apple Keynotes, Open Office Impress, Google Docs, and Adobe PDF have for the most part replaced the predecessor photographic slide and overhead projectors. These tools provide frame-based content, or slides, that allow the presenter to display for the audience a storyboard of the presentation.

A skilled presenter typically uses the storyboard as an outline, as well as recollection to keep his/her thoughts organized during delivery of the substance of the presentation through speech. As a result, much if not most, of the live presentation is not captured in the software. Audience members who request copies of the presentation, for example by e-mail or downloading from a website, will typically receive only the frame-based outline created by the software tool. Valuable parts of the presentation, including the presenter's voice-over, intonation, body language, and audience interactions, are typically not included in the outline.

One known method is to record the entire presentation, for example, using film or some other audio/video recorder that records time-based content of the entire presentation, i.e., continuous audio and video. The recording is posted as a link on a website, and made available for viewing or downloading by remote audience members. However, this option has several limitations. The camera may not be able to capture both the slides and the body language of the speaker. The video fails to capture the frame-based media in proper focus or with sufficient resolution for accurate retransmission over a computer network. The final recording is not easily edited or modified.

During a live presentation, the skilled presenter can receive audience reactions and tailor the presentation according to the needs of each audience. For example, the presenter experiences, during the display of certain slides, an absence of audience participation, or senses a general disinterest in the subject matter being presented. In either case, the presenter decides to spend more time on some slides, less on others, or go into further depth on some topics in response to audience participation. The presenter may ask the audience for information about specific interests, and tailor the presentation accordingly. Afterward, the presenter modifies the presentation in response to audience feedback by removing certain slides through selective editing.

Another method for recording an entire presentation is to embed multi-media, such as audio and video files, within the slides of frame-based software such as Microsoft Power Point. This technique requires that the voice-over be recorded, divided into individual audio files, and the files embedded into each of the slides. Uncertainty arises, however, when deciding where to divide the audio recording, and how to synchronize the audio with other visual effects or animation that are embedded in the slide. Worse yet, when editing the presentation, deleting a slide also erases any multi-media that are embedded within the slide, making selective editing more problematic.

Whether time-based or frame-based, current methods for packaging presentations for delivery over a computer network do not allow the presenter an effective means for assembling multi-media presentations, or for interacting with or receiving feedback from audience members who view the presentation remotely.

### SUMMARY OF THE INVENTION

In one embodiment, the present invention is a method of capturing a multi-media presentation for delivery over a computer network. The method includes steps for converting frame-based content from the presentation into a collection of slide assets of a multi-media file type, converting time-based content recorded during the presentation into a collection of audio/video assets of the multi-media file type, generating a presentation control file having a sequence of control segments, each control segment specifying a playback duration for one of the slide and audio/video assets and specifying placement information indicating control segment placement within the sequence, and packaging the slide assets, audio/video assets, and presentation control file as a collection of files readable by a player that, responsive to reading the presentation control file, plays the presentation as a series of synchronized assets according to the playback durations and placement information specified by the control segments.

In another embodiment, the present invention is a method of transmitting a multi-media presentation over a computer network. The method includes steps for converting frame-based content from the presentation into a collection of slide assets of a multi-media file type, converting time-based content recorded during the presentation into a collection of audio/video assets of the multi-media file type, generating a sequence of control segments, each control segment associating one of the slide assets with one of the audio/video assets, enabling playback of the presentation as a series of synchronized assets, and sequentially executing the control segments in a sequence according to the encoded sequence information, each control segment synchronizing display, on a network computer, of the slide asset with playback, on the network computer, of the associated audio/video asset.

In another embodiment, the present invention is a method of packaging a multi-media presentation for playback over a computer network and capture of audience feedback. The method includes steps for converting frame-based content from the presentation into a collection of slide assets of a multi-media file type, converting time-based content recorded during the presentation into a collection of audio/video assets of the multi-media file type, generating a presentation control file having a sequence of control segments, each control segment specifying a playback duration for one of the slide assets and for one of the audio/video assets and specifying placement information indicating control segment placement within the sequence, encoding a feedback prompt within one or more of the control segments, enabling playback of the presentation as a series of synchronized assets in a sequence according to the placement information, each control segment synchronizing display, on a network computer, of the slide asset with playback, on the network computer, of the audio/video asset, and enabling display of the feedback prompt on the network computer during playback of the presentation.

In another embodiment, the present invention is a method of synchronizing frame-based content from a multi-media presentation with time-based content delivered concurrently with the frame-based content. The method includes steps for providing a frame-selecting device for allowing a presenter to select from the frame-based content a current frame for display during the presentation, providing a recording device for recording the time-based content on a recording medium, recording on the recording medium a sequence of time codes, each time code representing time elapsed from presentation start until selection of a current frame by the frame-selecting device.

### BRIEF DESCRIPTION OF THE DRAWINGS

FIG. 1 is a block diagram illustrating a multi-media packaging and delivery system;

FIG. 2 is a method for capturing and packaging a multi-media presentation for delivery over a computer network;

FIG. 3 is another method for capturing and packaging a multi-media presentation for delivery over a computer network;

FIG. 4 is a block diagram illustrating packaging of a presentation as a collection of files readable by an embeddable player;

FIG. 5 is a process flow diagram for capturing a multi-media presentation for delivery over a computer network;

FIG. 6 is a process flow diagram for delivering a multi-media presentation over a computer network;

FIG. 7 is a process flow diagram for packaging a multi-media presentation for playback over a computer network and capture of remote audience feedback;

FIG. 8 is a system for synchronizing frame-based content from a multi-media presentation with a recording of time-based content from the multi-media presentation concurrently with live delivery of the presentation;

FIG. 9 is a device for enabling live synchronization of frame-based content from a multi-media presentation with a recording of time-based content from the multi-media presentation; and

FIG. 10 is a process flow diagram for synchronizing frame-based content from a multi-media presentation with a recording of time-based content captured concurrently with live delivery of the presentation.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

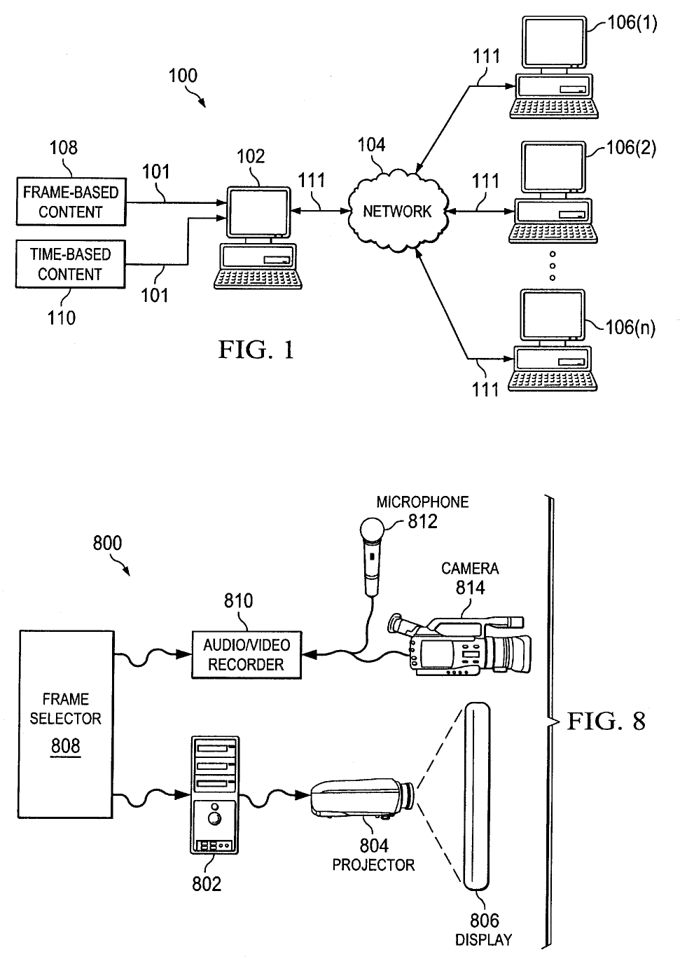

FIG. 1 shows a block diagram of a multi-media packaging and delivery system 100. The multi-media packaging and delivery system 100 is a computer-based communication network with electronic links 101 and 111 between parts of the system. Each of the communication links described herein can be direct hard-wired lines, leased high-bandwidth lines, telephone lines, fiber optic cable, wireless, satellite, or the like. Communication links 101 transfer media assets from a recorded presentation to network computer 102. Communication links 111 deliver the presentation to other network computers 106(1), 106(2), . . . 106(n) that are accessible in the system.

System 100 includes a presentation server 102 coupled to a number of network computers 106(1), 106(2), . . . 106(n) through electronic links 111 and network 104. Network 104 includes wired or wireless communication lines, modems, routers, and servers, such as a LAN, WAN, or the Internet. Presentation server 102 uploads over communication links 101, frame-based content 108, and time-based content 110 from a recorded presentation. Uploading frame-based content or time-based content includes transferring data from an electronic storage medium to presentation server 102 by e-mail or other known data transfer techniques or protocols.

Frame-based content 108 includes information displayed on frames, or slides, or static images, from a software tool such as Microsoft Power Point, Apple Keynotes, Open Office Impress, Google Docs, and Adobe pdf. The information can be shapes, text, fonts, still images, or animated graphics, i.e., the information typically displayed on frames that make up the presentation slide show.

Time-based content 110 can be audio or video information recorded for the presentation, or recorded during a live presentation of the frame-based content. For example, the content can be a digital audio/video recording of the presenter's narration of the slide show. As used herein, the term “audio/video” connotes either an audio recording or other audio asset, a video recording or other video asset, or a combination audio and video recording or asset. An “asset” is any source of stored or recorded information, whether audio, video, graphics, text, or any combination of the same.

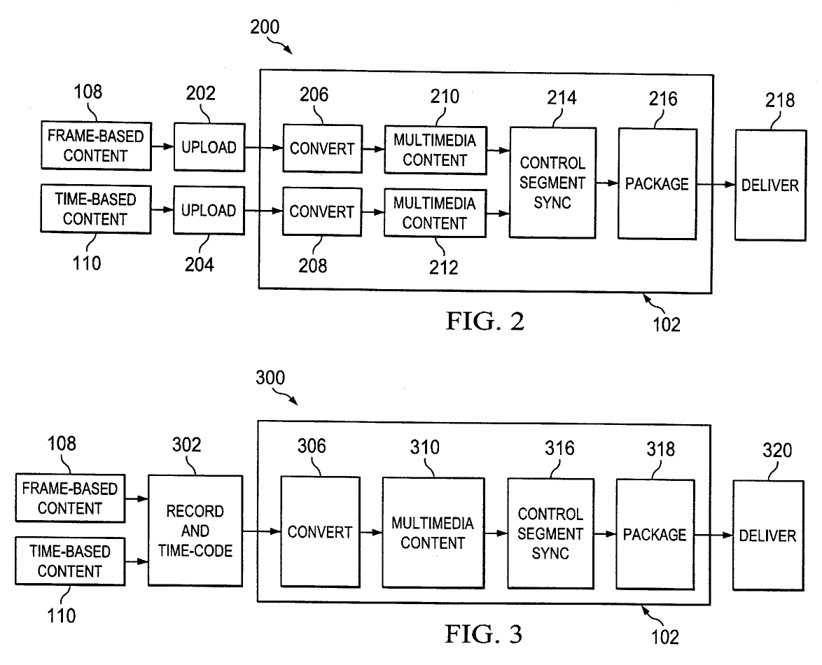

FIG. 2 is a block diagram representation of method 200 for capturing and packaging a multi-media presentation for delivery over a computer network. The multi-media presentation has separately stored or recorded frame-based content 108 and time-based content 110. In one implementation, these assets are separately uploaded, i.e., by electronic file transfer, as shown in blocks 202 and 204, to presentation server 102.

Presentation server 102 contains a number of modules (hardware, software, or a combination thereof) that prepare the assets for delivery over computer network 104. Conversion modules 206, 208 respectively convert the uploaded frame-based and time-based content into multi-media content, such as a collection of files created in a multi-media file format. Examples of multi-media file formats are FLV (Flash Video), GIF (Graphics Interchange Format), JPG (Joint Photographic Experts Group), M4V (video file format for iPods and PlayStation portables), MP3 (Moving Picture Experts Group-1 Audio Layer 3), MOV (Quick Time), PNG (Portable Network Graphics), SWF (Shockwave Flash), WMV (Windows Media Video), and XAML (Extensible Application Markup Language). The conversion modules transform MP3 or PPT file format into FLV or SWF files. Once these conversions are complete, the frame-based assets of the presentation is stored as one or more computer readable files SA1, SA2, . . . SAi (i is an integer) within the presentation server as multi-media content 210. The time-based assets of the presentation is stored as one or more computer readable files AV1, AV2, . . . AVj (j is an integer) within the presentation server as multi-media content 212.

In one embodiment, a control segment and synchronization module 214 is provided to associate multi-media content 210 with multi-media content 212 so that the presentation is accurately synchronized for replay in the converted multi-media file type. In one implementation, module 214 defines or generates a sequence of control segments CS1, CS2, . . . CSk (k is an integer). Each control segment specifies a playback duration for one of the slide and audio/video assets. Each control segment includes instructions in the form of computer readable code, for example, an executable code, for synchronizing one of the slide assets with one of the audio/video assets. In addition, each control segment specifies placement information indicating control segment placement within the sequence of control segments. For example, a control segment is encoded with sequence information. The sequence information is a flag or other portion of code that indicates when a particular control segment executes within the control segment sequence.

In one embodiment, a presentation is completely captured by uploading and converting all frame-based and time-based multi-media content of the presentation into a collection of files of a multi-media file type. The multi-media files are stored as computer readable multi-media content 210, 212. Each file is individually executable, and executed alone or in combination with one or more other multi-media files by a presentation control file generated by control segment sync module 214.

Packaging module 216 assembles all of the converted slide assets 210 and converted audio/video assets 212, along with the presentation control file that contains a series of control segments generated by control segment sync module 214, into a computer readable collection of files. The collection of files is delivered by presentation server 102 via a downloading operation or other file transfer method to any network computer 106(1), 106(2), . . . 106(n) within network 104. A network computer plays back the presentation by accessing a specialized player programmed or configured to read the presentation control file, and, responsive to reading the sequence of control segments contained in the presentation control file, play or display the multi-media files for the durations and in the sequence specified by the control segments. In one embodiment, the specialized player is an embedded media player or wrapper accessible by the network computer. When read or executed, the presentation control file instructs the player to call or execute each of the control segments in a sequence according to the sequence information encoded within each control segment. For example, an initial control segment is encoded as a first control segment in the sequence. At the conclusion of its execution, control passes to a second control segment that is encoded to follow the first. At the conclusion of execution of the second control segment, control passes to a third control segment that is encoded to follow the second, and so on, until control passes to a final control segment to conclude the presentation. Execution of any control segment in the series of control segments causes display of a particular slide asset, and simultaneously causes playback of one or more audio/video assets that have been synchronized to the particular slide asset being displayed. In this manner, the original slide presentation, including live audio/video content, is captured and delivered for rebroadcast on network computers for a remote audience.

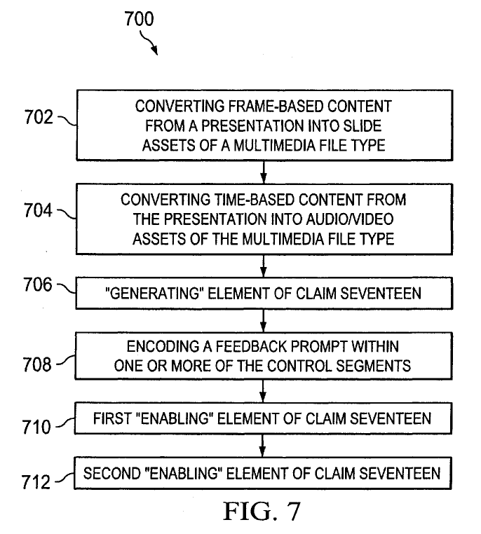

FIG. 3 is a block diagram representation of another method for capturing and packaging a multi-media presentation for delivery over a computer network. In this embodiment, synchronization of frame-based content 108 with corresponding time-based content 110 occurs while recording the presentation. The operation is represented in block 302, in which time-based content is recorded and time-coded during a live presentation of slides. One example of a system that makes the method possible is disclosed herein in further detail with reference to FIG. 7.

In module 302, time codes are added to a time-based recording, superimposed within the time-based recording, or separately logged in a time code file. Each time code corresponds to time elapsed from the start of the presentation until an advancement of the frame-based content from one slide to the next slide. The time-based content is then divided into a collection of time-coded audio/video assets, where each time-coded asset contains a portion of the time-based content that occurred during display of a particular slide. The time codes serve as indicators to divide the presentation into a sequence of control segments.

The frame-based content 108, time-based content 110, and time-coded information are uploaded to presentation server 102. These assets are converted for packaging by a series of modules (hardware, software, or a combination thereof) that prepare the assets for delivery over computer network 104. In module 306, the assets are converted into a multi-media file type such as SWF. In one implementation, the assets are converted into a plurality of multi-media files (AV1, AV2, . . . AVj and SA1, SA2, . . . SAi) represented by module 310. In one example, the files within multi-media content 310 include one file per slide asset, and one file per time-coded audio/video asset.

A synchronization module 316 generates a presentation control file containing a series of control segments (CS1, CS2, . . . CSk). Each control segment includes instructions readable by an embedded player for synchronizing one of the slide assets with one of the audio/video assets. In another embodiment, each control segment specifies a playback duration for one asset of the slide and audio/video assets. In another embodiment, each control segment specifies a playback duration for one of the slide assets and for one of the audio/video assets. Each control segment is encoded with placement information that indicates control segment placement within the sequence.

Packaging module 318 assembles all of the converted multi-media content 310 along with the presentation control file containing the series of control segments generated by control segment sync module 316 into a computer readable presentation file. The file is delivered by presentation server 102 via a downloading operation or other file transfer method to any network computer 106(1), 106(2), . . . 106(n) within the network 104. By accessing an embedded player, a network computer reads the presentation control file to rebroadcast the presentation as a sequence of converted slide assets, each slide asset being displayed and synchronized with playback of one or more converted audio/video assets. The display and playback sequence is synchronized according to the playback durations and placement information specified by the control segments.

A presentation file packaged in module 216 or 318 contains a collection of slide assets SA1, SA2, . . . SAi, a collection of audio/video assets AV1, AV2, . . . AVj, and a series of control segments CS1, CS2, . . . CSk. The control segments are encoded with sequence information that determines the order in which control passes from one control sequence to the next during a replay of the presentation. Each control segment associates and/or synchronizes one or more slide assets with one or more audio video assets.

In one implementation, each control segment controls the display of one slide asset, and synchronizes with the display the playback of one or more audio/video assets. In the case where more than one audio/video asset has been synchronized with a slide asset, during display of the slide asset, the control segment plays the audio/video assets concurrently or consecutively. In another implementation, more than one control segment controls the same slide asset or audio/video asset, but at different intervals in the control sequence. An example of a basic control sequence for a presentation is shown in Table 1 below. In this presentation, each slide has associated with it one audio/video asset, which may be the case, for example, in a presentation having narration.

TABLE 1

| Control Segment | Slide Asset | A/V Asset |
|---|---|---|
| CS1 | SA1 | AV1 |
| CS2 | SA2 | AV2 |
| CS3 | SA3 | AV3 |

An example of a control sequence for another presentation is shown in Table 2 below. In the control sequence of Table 2, control segments CS1 and CS3 play back the same audio/video asset AV1 at different control intervals. For example, AV1 is a recording of a sound effect that is used for two different slides. Control segments CS1 and CS5 display the same slide asset SA1 at different control intervals, for example, in a case where the first and final slide of the presentation are identical.

TABLE 2

| Control Segment | Slide Asset | A/V Asset |
|---|---|---|
| CS1 | SA1 | AV1, AV2 |
| CS2 | SA2 | AV3 |
| CS3 | SA3 | AV4, AV5, AV1 |
| CS4 | SA4 | AV6 |
| CS5 | SA1 | AV7 |

In another implementation, a more complex control sequence is used to display multiple slide assets at the same time. The control sequence is used to reproduce presentations that use multiple projectors or that have two displays presenting different frame-based content. Or, the complex control sequence is used to capture a presentation in the form of a panel discussion, where there are multiple presenters taking turns presenting information. In such a case, the presentation file causes the display of a network computer to divide its display screen to accommodate multiple images. Table 3 shows one example of a complex control sequence.

TABLE 3

| Control Segment | Slide Asset | A/V Asset |
|---|---|---|
| CS1 | SA1 | AV1 |
| CS2 | SA2, SA3 | AV2, AV3 |
| CS3 | SA4, SA5, SA6 | AV4, AV5, AV6 |
| CS4 | SA7, SA8 | AV7, AV8, AV9 |
| CS5 | SA1 | AV1 |

In another embodiment, a control segment causes an audio/video asset to be presented without a slide asset being displayed. For example, a presenter plays a film or video clip as part of the presentation. The video is presented in a “full-screen” view and dominates the display during some time interval in the course of the presentation. The control sequence shown in Table 4 provides an illustrative example for this scenario, in which asset AV4 comprises a film clip.

TABLE 4

| Control Segment | Slide Asset | A/V Asset |
|---|---|---|
| CS1 | SA1 | AV1 |
| CS2 | SA2 | AV2, AV3 |
| CS3 | | AV4 |
| CS4 | SA7, SA8 | AV7, AV8, AV9 |
| CS5 | SA1 | AV1 |

It is also possible for an audio/video asset such as AV4 of Table 4 to provide audio only. Or, AV4 provides a combined audio and video clip from a multi-media file, such as a SWF file stored within the presentation file, or stored elsewhere in network 104. For example, AV4 is a file accessible on a public website such as YouTube.com. Control segment CS3 executes an algorithm that accesses the audio/video asset on the public website, and specifies that all or some part of the asset be played. At the conclusion of the clip, control passes to the next control segment, which in this example is CS4, and the control sequence would then continue according to the sequence information encoded within the control segment series.

The control segments specify display or retrieval of other resources or assets in addition to converted frame-based and time-based content. For example, during a presentation, a speaker displays a related resource such as a web page or a file accessible from computer memory. The file contains a spreadsheet, a database demo, a copy of a white paper, etc. A control segment specifies that a hyperlink (e.g., URL text) or shortcut be displayed along with a slide asset, so that a remote viewer selects the hyperlink. Selecting the hyperlink would then cause the associated web page to appear, or cause the file to open (e.g., in PDF format).

In another example, during the presentation, a speaker displays a slide-based assets or time-based assets available via the Internet from other media providers. A control segment specifies that an embedded player link (via URL) to one or more assets in an asset library residing on a remote server, such as YouTube, Flicker, Picasa, PhotoBucket, and Facebook, or on another source accessible by URL. When linking to an audio/video asset on a remote server, the control segment includes instructions for playing back a portion of the audio/video asset. The control segment also provides user account information to allow the player to access a remote library.

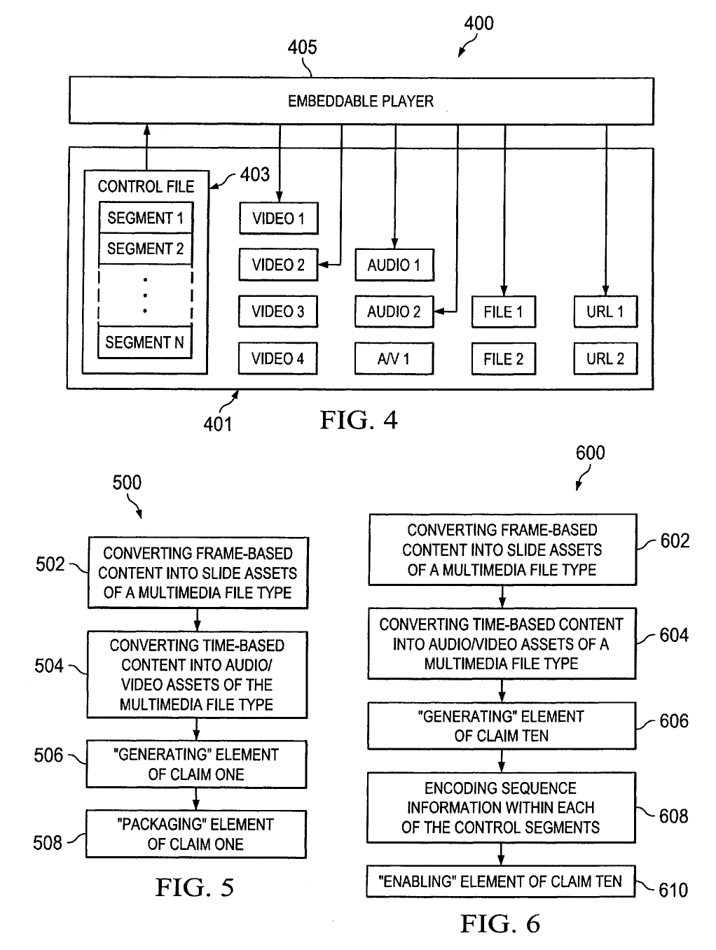

FIG. 4 shows a block diagram 400 of a presentation packaged for delivery to a network computer for playback by an embedded player. The package is delivered as a collection of files 401. File collection 401 contains a presentation control file 403, a plurality of assets VIDEO 1, VIDEO 2, VIDEO 3, VIDEO 4, AUDIO 1, AUDIO 2, A/V 1, and a plurality of related resources FILE 1, FILE 2, URL 1, and URL 2. Presentation control file 403 contains a sequence of control segments SEGMENT 1, SEGMENT 2, . . . SEGMENT N (N is an integer). Each control segment specifies playback duration for one of the plurality of assets, specifies that a hyperlink pointing to one of the related resources be displayed concurrently with an asset, and specifies placement information indicating control segment placement within the sequence.

An embeddable player 405, accessible by a network computer receiving collection 401, reads presentation control file 401 and, responsive to reading the presentation control file, plays back the presentation by playing the assets in the sequence specified by the control segments according to the playback durations and placement information. In addition, the embeddable player displays, for user selection, a hyperlink pointing to a related resource concurrently with one or more assets. Selection of the displayed hyperlink by a remote viewer allows the network computer to display the related resource.

An example of a control sequence for a presentation containing hyperlinks to related resources (RRsc) is shown in Table 5. In this example, control segment CS2 specifies that a hyperlink to URL1 be displayed concurrently with slide asset SA2 for a specified duration. Control segment CS4 specifies that a hyperlink or shortcut to FILE2 be displayed concurrently with slide asset SA7 or SA8 (or both SA7 and SA8) according to a specified duration.

TABLE 5

| Control Segment | Slide Asset | A/V Asset | RRsc |
|---|---|---|---|
| CS1 | SA1 | AV1 | |
| CS2 | SA2 | AV2, AV3 | URL1 |
| CS3 | | AV4 | |
| CS4 | SA7, SA8 | AV7, AV8 | FILE2 |
| CS5 | SA1 | AV1 | |

Turning now to FIG. 5, a process flow diagram of method 500 for capturing a multi-media presentation for delivery over a computer network. Method 500 begins at step 502, which provides for converting frame-based content from the presentation into a collection of slide assets of a multi-media file type. The frame-based content is converted from information contained in static displays or slides from the presentation, and includes information pertaining but not limited to shapes, colors, graphics, text, and fonts. In one variation, the multi-media file type includes data encoded in SWF file format. In step 504, time-based content from the presentation is converted into a collection of audio/video assets of a multi-media file type, which is the same file type as the collection of slide assets. The time-based content includes audio recordings, video recordings, or a combination thereof, that were recorded during a display of the frame-based content. In step 506, the method provides for generating a presentation control file having a sequence of control segments. Each control segment generated in step 506 specifies playback duration for one asset of the slide asset and audio/video assets, and specifies placement information indicating control segment placement within the sequence. Step 506 ensures that during execution of any control segment, the playback of audio/video assets, or any portion thereof, that are associated with a particular slide asset will occur during display of the particular slide asset. In step 508, the method provides for packaging the slide assets, the audio/video assets, and the presentation control file as a collection of files readable by a player that, responsive to reading the presentation control file, plays the presentation as a series of assets synchronized according to the playback durations and placement information specified by the control segments.

FIG. 6 provides a process flow diagram of method 600 for delivering a multi-media presentation over a computer network. The first two steps 602 and 604 are similar to steps 502 and 504 of the previous embodiment. These steps convert frame-based content into slide assets of a multi-media file type, and convert time-based assets into audio/video assets of the multi-media file type.

In step 606, method 600 provides for generating a sequence of control segments, wherein each control segment associates one of the slide assets with one of the audio/video assets. In step 608, the method encodes sequence information within each of the control segments. In step 610, the method enables playback of the presentation as a series of synchronized assets in a sequence according to the encoded sequence information, where each control segment synchronizes display, on a network computer, of the slide asset with playback, on the network computer, of the associated audio/video asset.

The concept of encoding a series of individual control segments that synchronize slide assets with audio/video assets provides many advantages over frame-based or time-based presentation schemes. One of these advantages is the enabling of interactive features through which feedback is solicited from a remote audience that views the presentation asynchronously, i.e., at a time subsequent to the live presentation. Another advantage is that the control segments allow a single presentation to be tailored for more than one audience, in response to the audience feedback. Another advantage is that the author, or presenter, encodes passive feedback prompts within the control segments to set up automatic collection of remote or live audience feedback, from which feedback metrics or per-slide analytics is collected to assist the presenter in optimizing the presentation. As used herein, interactive feedback refers to audience feedback that alters the sequence of control segments in a presentation being transmitted. Passive feedback refers to audience feedback that does not affect the sequence of control segments in a presentation being transmitted.

One example of an interactive feature is a quiz. The quiz (or quiz asset) is encoded as any other asset in the presentation file and made available for display during playback of a presentation by any control segment in the control sequence. In one embodiment, the quiz asset, when executed, is displayed on a network computer as one or more questions for the viewer. A feedback prompt in the form of a graphical button or text field is provided on the display to receive user feedback, e.g., in the form of an answer to the quiz, through a known data transfer technique. With reference to FIG. 1, the audience feedback flows from network computer 106(1), 106(2), . . . 106(n) via electronic link 111 to presentation server 102 over network 104. The presentation server 102 collects and stores the audience feedback, and later analyzes the feedback to allow the presenter to assess the effectiveness of the presentation.

Alternatively, the audience feedback is used to alter the control sequence among the control segments. For example, in a scenario where the presentation is being simultaneously transmitted, or “webcast” to a number of remote viewers, a control segment executes a quiz asset and suspends the presentation until sufficient feedback is received to assess whether the viewers have grasped the substance of a lesson being presented. If so, the presentation server causes the control segment to pass control to the next control segment in a normal sequence. If not, the presentation server causes the control segment to pass control to a previous control segment, essentially “rewinding” the presentation to an earlier slide so that a certain lesson is repeated.

Other forms of interactive audience feedback are possible. For example, a feedback prompt asks whether a particular slide asset has been helpful to the viewer, without suspending the presentation. Another type of feedback prompt quizzes the viewers for specific information about the make-up of the remote audience. For example, the quiz asks how many audience members have a particular business interest. If the collective audience feedback indicates that a threshold of relevant members has been met, the presentation server skips past one or more control segments in the normal sequence, or adds additional control segments to the sequence, as the case may be.

Other feedback prompts are enabled in a method to solicit passive feedback. In one implementation, rather than passing control automatically from one control segment to the next, one or more control segments in the series of control segments is coded to suspend transfer to a subsequent control segment until a forwarding command is received from the viewer. Presentation server 102 measures the time that each viewer spends reviewing a particular slide asset until the forwarding command is received. The average time spent by a viewer reviewing a slide is an example of a per-slide analytic. If on average, too much or too little time is spent observing a particular slide, the presenter wants to remove the slide or modify the control segment associated with the slide to improve communication.

Another type of feedback prompt is a skip asset that allows a viewer to skip past a slide asset, or past a remaining portion of time for which a slide asset would be displayed until an associated audio/video asset finishes playing. The skip asset is displayed as an option for viewer selection on a network computer. The presentation server collects data indicating viewer use of the skip option, and derives various feedback metrics and per-side analytics. The number of times that viewers skip a particular slide asset, the frequency with which viewers skip slides as a presentation progresses, and timing of skip requests after an audio/video asset has begun to play are further examples of passive audience feedback.

FIG. 7 provides a process flow diagram of method 700 for packaging a multi-media presentation for playback over a computer network and capture of remote audience feedback. The first two steps 702 and 704 are similar to steps 502 and 504 of method 500. These steps convert frame-based content into slide assets of a multi-media file type, and convert time-based assets into audio/video assets of the multi-media file type.

In step 706, the method provides for generating a presentation control file having a sequence of control segments, where each control segment specifies a playback duration for one of the slide assets and for one of the audio/video assets, and specifies placement information indicating control segment placement within the sequence. In step 708, a feedback prompt is encoded within one or more of the control segments. The feedback prompt contains executable instructions that when executed, cause the display on a network computer of an option for the viewer. The option is a quiz asset, or a skip asset, or some other mechanism for soliciting remote audience feedback, such as a text field that asks for viewer comments. In step 710, the method provides for enabling playback of the presentation as a series of synchronized assets in a sequence according to the placement information, each control segment synchronizing display, on a network computer, of the slide asset with playback, on the network computer, of the audio/video asset. In step 712, the method provides for enabling the feedback prompt to display on the network computer during execution of the one or more control segments containing the feedback prompt, to solicit audience feedback.

Turning now to FIG. 8, a block diagram is shown for one embodiment of system 800 for synchronizing frame-based content from a multi-media presentation with a recording of time-based content from the multi-media presentation concurrently with live delivery of the presentation. The system includes a computer system 802, which is a desktop or laptop personal computer running an operating system such as Microsoft Windows, MAC OS, OS/2, Linux, etc., and including in memory accessible by the operating system a frame-based presentation software tool such as Microsoft Power Point, Apple Keynotes, or Open Office Impress. A projector 804 is electronically linked to computer 802 to project images of the presentation to a display 806. In another embodiment, projector 804 and display 806 is one and the same, such as a flat screen monitor.

A frame selector 808 is electronically linked to computer 802. Frame selector 808 is a handheld device that when triggered by a presenter, sends a frame selection signal to computer 802, causing the computer to advance the frame-based presentation from a current frame to the next frame in the presentation. An audio/video recording device 810 can also be electronically linked to frame selector 808 for receiving frame selection signals. Audio/video recording device 810 receives analog or digital audio signals, video signals, or combination audio/video signals, and records digital audio and/or digital video signals. In one embodiment, audio/video recording device 810 is an integral part of computer 802. One or both of a microphone 812 and a video camera 814 provides a source of the audio/video signals to be recorded by audio/video recording device 810. All components in system 800 are electronically linked as shown by wired or wireless communication link.

To synchronize the stored frame-based content of the presentation with live audio/video generated during a live presentation of the frame-based content, a presenter grasps the frame selector 808 and depresses a button or trigger on the frames selector 808 to cause computer 802 to display the first slide of the presentation on display 806. The presenter then narrates the presentation while one or both audio/video recording devices 812 and 814 record sights and sounds. Frame selector 808 is specially designed to facilitate synchronization of the audio/video recordings with the frame-based content being displayed when those assets are later converted to multi-media file format for packaging and distribution of the presentation over a computer network.

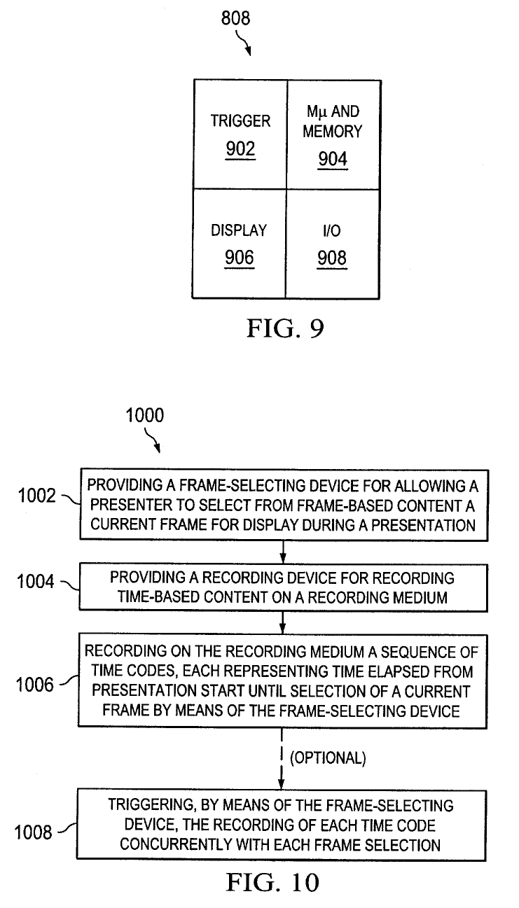

A block diagram of one embodiment of a frame selector 808 is shown in FIG. 9. Frame selector 808 includes a trigger or hand switch 902, and optionally includes a microprocessor and memory module 904, miniature display 906, and input/output module 908. Module 904 allows a presenter to store the entire frame-based content of a presentation within frame selector 808, so that the software executes, but need not be copied to computer 802. The presenter is provided with better security for situations where the content of the presentation includes confidential information. Display module 906 provides a miniature display of the presentation that mirrors whatever frame is being shown on display 806. The feature allows the presenter to follow the slides and maintain better contact with the live audience without having to refer to the main presentation screen. Input/output module 908 provides all software and hardware required for frame selector 808 to interface with other components in the system.

Each time trigger 902 is toggled or clicked, it generates a frame selection signal that is sent to computer 802 and also to audio/video recorder 810. The frame selection signal causes the presentation to advance one frame forward, and at substantially the same time, causes audio/video recorder 810 to store a time code. As the presentation continues, a series of time codes is recorded as a time-coded click stream. The time codes are added by the audio/video recorder to a time-based audio or video recording, superimposed within the time-based recording, or separately logged in a time-code file. Each time code in the click stream corresponds to time elapsed from the start of the presentation until an advancement of the frame-based content from one slide to the next slide. The time codes serve as indicators to divide the presentation into control segments. In this way, each time-coded asset contains a portion of the time-based content that occurred during display of a particular slide.

With reference again to FIG. 3, during uploading and conversion of time-based content 110 to presentation server 102, the time-coded click stream allows conversion module 306 to automatically divide the time-based content into a collection of audio/video assets. Each audio/video asset is automatically associated, sequentially, with its corresponding converted slide asset.

FIG. 10 provides a process flow diagram to illustrate method 1000 for synchronizing frame-based content from a multi-media presentation with a recording of time-based content captured concurrently with live delivery of the presentation. Method 1000 begins at step 1002, which provides a frame-selecting device for allowing a presenter to select from frame-based content a current frame for display during the presentation. In step 1004, the method provides a recording device for recording the time-based content on a recording medium. In one embodiment, the recording medium is computer readable memory, and the time-based content is audio signals, video signals, or a combination of the two. In step 1006, the method provides for recording on the recording medium a sequence of time codes, where each time code represents time elapsed from presentation start until selection of a current frame by the frame-selecting device. The time codes are superimposed on the audio/video recording, or recorded in a separate file, for example, as a time-coded click stream.

An optional step 1008 is provided in method 900. The optional step provides for triggering, by the frame-selecting device, the recording of each time code concurrently with each frame selection.

While one or more embodiments of the present invention have been illustrated in detail, the skilled artisan will appreciate that modifications and adaptations to those embodiments may be made without departing from the scope of the present invention as set forth in the following claims.

What is claimed:

1. A method of capturing a multi-media presentation for delivery over a computer network, comprising:
converting frame-based content from the presentation into a collection of slide assets of a multi-media file type;
converting time-based content recorded during the presentation into a collection of audio/video assets of the multi-media file type;
generating a presentation control file having a sequence of control segments, each control segment specifying a playback duration for one of the slide and audio/video assets, and specifying placement information indicating control segment placement within the sequence; and
packaging the slide assets, audio/video assets, and presentation control file as a collection of files readable by a player that, responsive to reading the presentation control file, plays the presentation as a series of assets synchronized according to the playback durations and placement information specified by the control segments.

2. The method of claim 1, wherein the multi-media file type is selected from the group consisting of FLV, GIF, JPG, M4V, MP3, MOV, PNG, SWF, WMV, and XAML.

3. The method of claim 1, wherein the frame-based content includes a plurality of static displays from the presentation.

4. The method of claim 1, wherein the time-based content includes one or more of audio and video recorded during the presentation.

5. The method of claim 1, wherein the playback duration represents a selected portion of a total duration of the audio/video asset.

6. The method of claim 1, wherein one of the control segments specifies that the asset be displayed during the playback duration.

7. The method of claim 1, wherein one of the control segments synchronizes a first slide asset with a first audio/video asset and another control segment synchronizes the first slide asset with a second audio/video asset.

8. The method of claim 1, wherein one of the control segments synchronizes a first slide asset with a first audio/video asset and another control segment synchronizes a second slide asset with the first audio/video asset.

9. The method of claim 1, wherein one of the control segments synchronizes a first slide asset with multiple audio/video assets.

10. A method of delivering a multi-media presentation over a computer network, comprising:
converting frame-based content from the presentation into a collection of slide assets of a multi-media file type;
converting time-based content recorded during the presentation into a collection of audio/video assets of the multi-media file type;
generating a sequence of control segments, each control segment associating one of the slide assets with one of the audio/video assets;
encoding sequence information within each of the control segments; and
enabling playback of the presentation as a series of synchronized assets in a sequence according to the encoded sequence information, each control segment synchronizing display, on a network computer, of the one slide asset with playback, on the network computer, of the associated one audio/video asset.

11. The method of claim 10, wherein the slide assets, audio/video assets, and control segments are packaged as a collection of files readable by an embedded player accessible by the network computer.

12. The method of claim 10, wherein the multi-media file type is selected from the group consisting of FLV, GIF, JPG, M4V, MP3, MOV, PNG, SWF, WMV, and XAML.

13. The method of claim 10, wherein the frame-based content comprises a plurality of static images from the presentation.

14. The method of claim 10, wherein the time-based content includes one or more of audio and video recorded during the presentation.

15. The method of claim 10, wherein each of the audio/video assets is time-coded to allow a control segment to specify a selected portion of the audio/video asset to play.

16. A method of packaging a multi-media presentation for playback over a computer network and capture of audience feedback, comprising:
converting frame-based content from the presentation into a collection of slide assets of a multi-media file type;
converting time-based content recorded during the presentation into a collection of audio/video assets of the multi-media file type;
generating a presentation control file having a sequence of control segments, each control segment specifying a playback duration for one of the slide assets and for one of the audio/video assets, and specifying placement information indicating control segment placement within the sequence;
encoding a feedback prompt within one or more of the control segments;
enabling playback of the presentation as a series of synchronized assets in a sequence according to the placement information, each control segment synchronizing display, on a network computer, of the slide asset with playback, on the network computer, of the audio/video asset; and
enabling display of the feedback prompt on the network computer during playback of the presentation.

17. The method of claim 16, wherein the slide assets, the audio/video assets, and the control segments are packaged as a collection of files readable by an embedded player accessible by the network computer.

18. The method of claim 16, wherein the frame-based content includes a plurality of static images from the presentation, and the time-based content comprises one or more of audio and video recorded during the presentation.

19. The method of claim 16, wherein the multi-media file type is selected from the group consisting of FLV, GIF, JPG, M4V, MP3, MOV, PNG, SWF, WMV, and XAML.

20. The method of claim 16, further comprising receiving audience feedback via the network computer, and, responsive to the audience feedback, changing the sequence of control segment placement.

21. The method of claim 16, further comprising encoding each control segment with a feedback prompt that suspends the presentation after display of the slide asset until audience feedback is received via the network computer, and enabling collection of data indicating time of display of the slide asset.

22. The method of claim 16, further comprising enabling display of the feedback prompt on the network computer while the one or more control segments containing the feedback prompt synchronize display of the slide asset with playback of the audio/video asset.

23. A method of synchronizing frame-based content from a multi-media presentation with a recording of time-based content from the multi-media presentation concurrently with live delivery of the presentation, the method comprising:
providing a frame-selecting device for allowing a presenter to select from the frame-based content a current frame for display during the presentation;
providing a recording device for recording the time-based content on a recording medium; and
recording on the recording medium a sequence of time codes, each time code representing time elapsed from presentation start until selection of a current frame by the frame-selecting device.

24. The method of claim 23, wherein the frame-selecting device triggers the recording of each time code concurrently with each frame selection.

25. The method of claim 23, wherein the sequence of time codes is recorded separately from the time-based content.
